(19) United States
(12) Patent Application Publication
(10) Pub. No.: US 2019/0050788 A1
(43) Pub. Date: Feb. 14, 2019

(54) Techniques for pre-scheduled dispatching non-electronic correspondence on behalf of a sender

(71) Applicant: Alexander D. Lantsman, Neptune, NJ (US)

(72) Inventor: Alexander D. Lantsman, Neptune, NJ (US)

(21) Appl. No.: 15/673,412

(22) Filed: Aug. 9, 2017

(51) Int. Cl. G06Q 10/08

(52) U.S. Cl. CPC G06Q 10/083

(57) ABSTRACT

Techniques for pre-scheduled dispatching non-electronic correspondence on behalf of a sender are disclosed. Parcels containing sender-defined portions of the correspondence are provided to a depository adapted for dispatching the parcels to their recipients after occurrence of one of pre-determined by the sender events. Alternatively, the parcels are placed in a sender post-office box or safe deposit box and dispatched therefrom after occurrence of such an event.

### BACKGROUND OF THE INVENTION

### 1. Technical Field

The present invention relates to the field of delivery services.

### 2. Description of the Related Art

Sending non-electronic correspondence may be problematic when a sender is not available for depositing the correspondence with a receiving facility (e.g., drop-off box, courier, manned office) of a respective common carrier, such as U.S. Postal Service, FedEx®, UPS®, etc. In this case, timely delivery of the correspondence to their recipients is dependent on cooperation of members of household or acquaintances of the sender, their ability to locate and correctly post the correspondence, and other factors.

### BRIEF SUMMARY OF THE INVENTION

Sender instructions and parcels containing pre-defined portions of non-electronic correspondence are provided to a depository coupled to a delivery services network of a common carrier. The instructions contain a listing of events which occurrences require dispatching of the parcels to their recipients. The depository is adapted for preserving the parcels and accepting notices of occurrences of these events. After occurrence of one of the events, the depository dispatches the parcels to the recipients.

In alternate embodiments, the parcels are placed in a sender post-office box or sender safe deposit box, while the instructions and a sender behest for dispatching the parcels therefrom are provided to the depository.

Various other aspects and embodiments of the invention are described in further detail below. It has been contemplated that features of one embodiment of the invention may be incorporated in other embodiments thereof without further recitation.

The Summary is neither intended nor should it be construed as being representative of the full extent and scope of the present invention, which these and additional aspects will become apparent from the detailed description and appended drawings. The novel features believed being characteristic of the present invention are set forth in the appended claims.

### BRIEF DESCRIPTION OF THE DRAWINGS

FIG. 1 is a diagram illustrating a method of pre-scheduled dispatching non-electronic correspondence on behalf of a sender in one or more embodiments of the invention.

FIG. 2 is a diagram illustrating techniques for pre-scheduled dispatching non-electronic correspondence in accordance with the method of FIG. 2.

FIG. 3 is a diagram illustrating another method of pre-scheduled dispatching non-electronic correspondence on behalf of a sender in one or more embodiments of the invention.

FIG. 4 is a diagram illustrating techniques for pre-scheduled dispatching non-electronic correspondence in accordance with the method of FIG. 3.

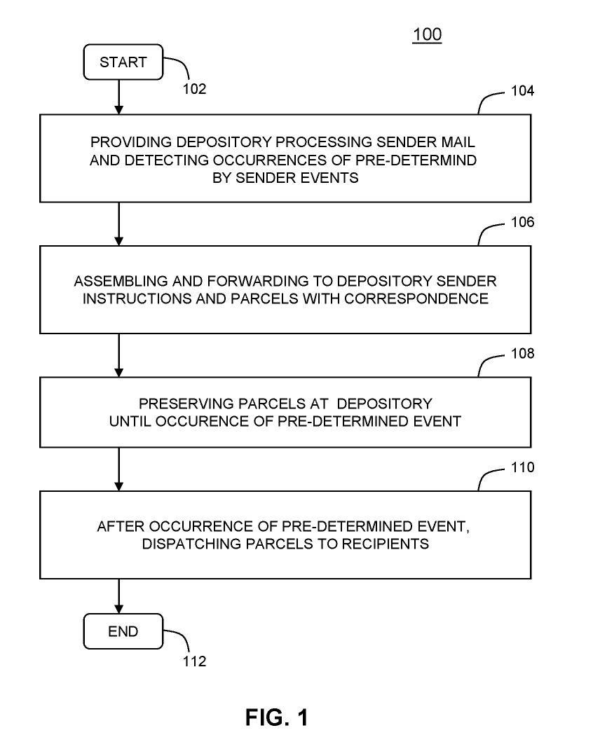

Images and legends in FIGS. 1-4 are simplified for illustrative purposes and brevity. To facilitate understanding, identical reference numerals are used in the drawings to designate, where possible, substantially identical elements that are common to the figures, except that alphanumerical extensions and/or suffixes may be added, when appropriate, to differentiate such elements.

### DETAILED DESCRIPTION OF THE INVENTION

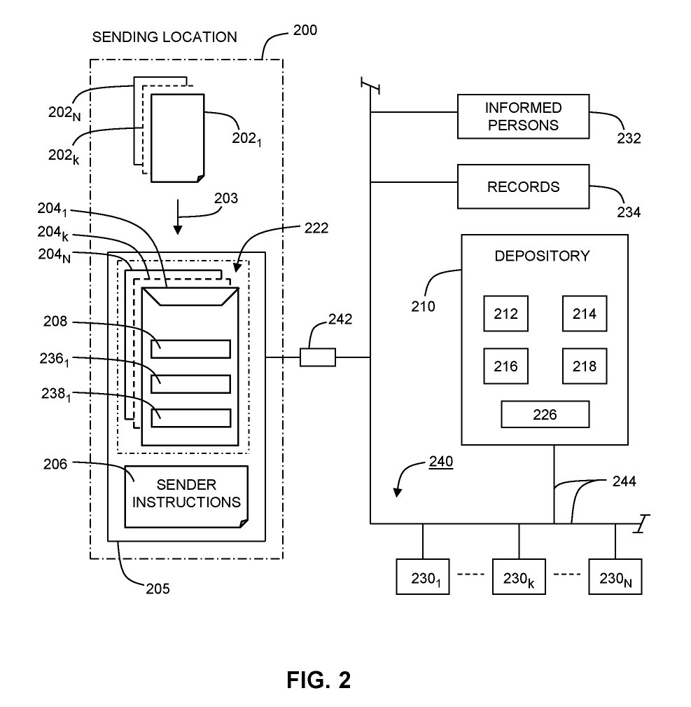

With reference to FIG. 1, there is depicted a diagram of a method 100 for pre-scheduled dispatching non-electronic correspondence on behalf of a sender in one or more embodiments of the invention. Various techniques for implementing the method 100 are illustrated in FIG. 2. The reader is suggested to refer to FIGS. 1 and 2 simultaneously.

The method 100 begins at step 102 and proceeds to step 104. At step 104, a depository 210 for sender mail 205 is provided. The depository 210 is coupled to a delivery services network 240 of a common carrier (e.g., U.S. Postal Service, FedEx®, UPS®, etc.) and adapted for receiving, storing/preserving and dispatching portions of the mail 205. In one embodiment, the depository 210 is a portion of the same or different common carrier.

The depository 210 is adapted for processing sender mail received from a plurality of senders, and may be a separate entity or a portion of a business entity (e.g., financial, insurance, information or delivery services entity). The network 240 includes a plurality of bi-directional delivery routes 244 and a plurality of mail processing facilities, such as drop-off boxes, couriers, offices, etc. (only a facility 242 servicing a sender location 200 is shown).

The mail 205 generally includes sender instructions 206 and sender correspondence 222. The correspondence 222 includes one or more parcels 204ₖ each defined by the sender for delivery to a respective recipient (i.e., addressee) 230ₖ, wherein k is an integer and 1≤k≤N. The terms “recipient(s)” and “addressee(s)” are used hereafter interchangeably.

The instructions 206 include at a listing of pre-determined by the sender events which occurrences require dispatching of the parcels 204₁-204_{N} to the recipients 230₁-230_{N}. Such events may include a date pre-set by the sender, a directive of the sender for prompt dispatching the parcels 204₁-204_{N}, death or disappearance of the sender, and other events.

In other embodiments, the instructions 206 also include a listing of names 236₁-236_{N} and delivery addresses 238₁-238_{N} of the recipients 230₁-230_{N}. The instructions 206 may include other sender requests (e.g., reports on status of the correspondence 222, etc.). Generally, the instructions 206 are notarized, certified, witnessed or signed by the sender non-electronic documents.

The term “sender” is used herein in reference to a person who addressed (i.e., provided a name and return address) the mail 205, parcels 204₁-204_{N} and instructions 206, and the term “absentee sender” is used below in reference to the sender after occurrence of one of the pre-determined events.

Notices of occurrences of the events may be received and/or requested by the depository 210 from members of household, relatives and acquaintances of the sender (collectively “Informed Persons” 232) and/or from sources of official records, including police, military, government, etc. records (collectively “Records” 234).

In one embodiment, the depository 210 illustratively includes a receiving unit 212 adapted for accepting and registering contents of the mail 205, a storage unit 214 adapted for storing and preserving portions of the mail 205, a monitoring unit 216 adapted for accepting and verifying notices of occurrences of the pre-determined events, a distributing unit 218 adapted for dispatching the parcels 204₁-204_{N} according to the instructions 206, and a database 226.

Herein, the term “unit” refers to a means of the depository 210 adapted for performing a particular function. The units of the depository 210 may be located at the same or different locations, as well as be portions of one or several business entities.

At step 106, the mail 205 is assembled (e.g., by the sender at the location 200) and provided to a facility of the network 240 (as depicted, to the facility 242) for delivery to the depository 210. For example, the mail 205 may be forwarded (i.e., sent) to the depository 210 using U.S. Postal Service, FedEx®, UPS®, etc.

In one embodiment, the parcels 204₁-204_{N} of the correspondence 222 include pre-defined by the sender non-electronic (i.e., executed on paper) documents 202₁-202_{N} which are selectively placed (illustrated with an arrow 203) in separate parcels. The documents 202₁-202_{N} generally are legal, financial, official or personal documents of the sender. Additionally or alternatively, the parcels 204₁-204_{N} may contain computer media (e.g., CD/DVD discs, memory cards, flash drives, etc.) and/or other tangible items.

In other embodiments, the parcels 204₁-204_{N} contain sender notes disclosing location of and access to the documents 202₁-202_{N} (e.g., notes disclosing location of a sender safe deposit box (or safe) and/or an authorization (or code) for accessing contents thereof).

In one embodiment, the parcels 204₁-204_{N} are selectively marked (or labeled) with a name/return address 208 of the sender and the names 236₁-236_{N} and delivery address 238₁-238_{N} of the recipients 230₁-230_{N}, and sealed. In an alternate embodiment, the delivery addresses 238₁-238_{N} of the recipients 230₁-230_{N} are provided only in the instructions 206.

In embodiments, the parcels 204₁-204_{N} could be shipping envelopes, cartons or boxes. Optionally, the parcels 204₁-204_{N} are placed in a common enclosure (not shown) addressed to the depository 210. To provide efficient utilization of storage facilities of the unit 214, the parcels 204₁-204_{N} or enclosure may have standard for mailing/shipping operations dimensions.

The documents 202₁-202_{N} may include Will/Testament, Payable/Transferable-on-Death Asset(s) or Trust(s) documents of the sender, and the addressees 230₁-230_{N} may include beneficiaries, estate executors, trustees, attorneys, etc. and/or a probate court having jurisdiction over municipality of residence or estate of the sender. In these applications, the pre-determined events generally include death or disappearance of the sender, and a notice from the Informed Persons 232 or Records 234 could be Death Certificate of the sender.

The instructions 206 are addressed to the depository 210. Optionally, the instructions 206 are placed in a shipping envelope or enclosure (both not shown).

At step 108, the parcels 204₁-204_{N} are received by the depository 210. Addressing data of the parcels 204₁-204_{N} and content of the instructions 206 are recorded in the database 226. Discrepancies affecting delivery of the parcels 204₁-204_{N} to their recipients 230₁-230_{N} (e.g., missing/corrupted articles, mismatched names or addresses, etc.) are reported to the sender.

The parcels 204₁-204_{N} and, optionally, instructions 206 are transferred to the storage unit 214, where they are stored and preserved in a shelf compartment or in a transportable container that is compatible with automated loading/unloading equipment and provided with machine-readable identifiers (e.g., RFID tags, 1D/2D barcodes, etc.).

The notices from the Informed Persons 232 and Records 234 regarding occurrences of the pre-determined by the sender events may be provided to the depository 210 by mail (as shown) and/or electronically (e.g., by phone, fax, or e-mail). Prior to receipt of the notices, at a sender request the depository 210 may replace or return the parcels 204₁-204_{N} or instructions 206.

In embodiments, these notices may include Death Certificate of the sender, police, military or medical records, judicial decisions, etc. To detect if the sender became an absentee sender, the depository 210 may perform searches for such data, as well as verify validity of the received notices (e.g., by contacting the Informed Persons 232, Records 234 or sender).

Content of the instructions 206 and notices from/inquiries to the sender, Informed Persons 232 and Records 234, and data on processing of the parcels 204₁-204_{N} in the depository 210 are stored in the database 226.

At step 110, after detecting/verifying a notice of occurrence of one of the pre-determined events, the depository 210 dispatches, via the network 240, the parcels 204₁-204_{N} to the recipients 230₁-230_{N}.

When the delivery addresses 238₁-238_{N} of the recipients 230₁-230_{N} are provided only in the instructions 206, these addresses are copied therefrom and marked (or labeled) on the parcels 204₁-204_{N} at the depository after receiving such a notice. Upon completion of step 110, the method 100 ends at step 112.

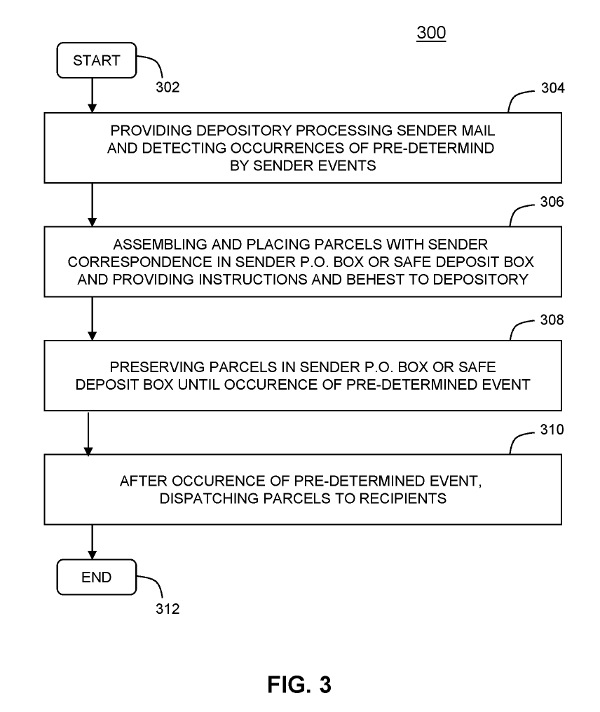

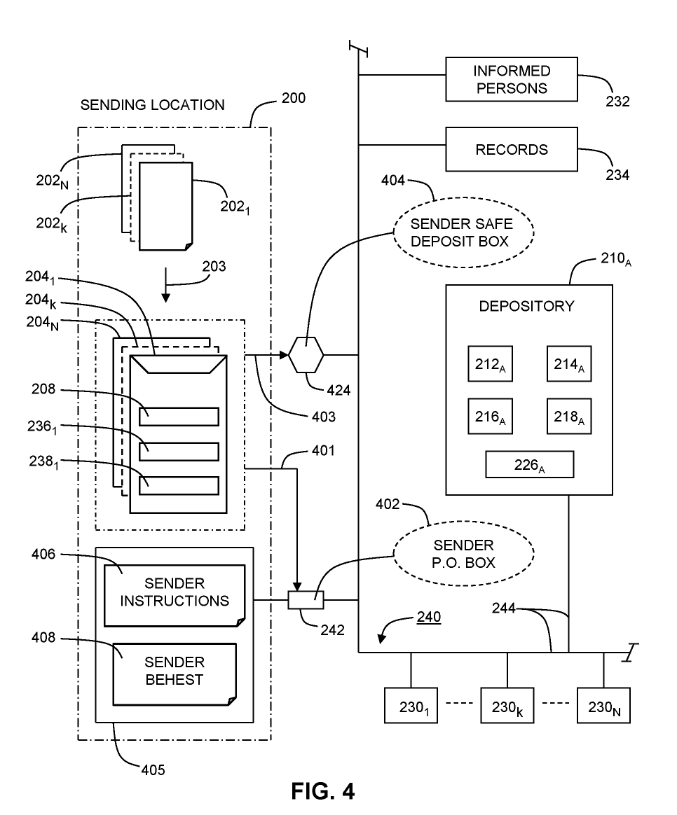

With reference to FIG. 3, there is depicted a diagram of a method 300 for pre-scheduled dispatching non-electronic correspondence on behalf of the sender in one or more embodiments of the invention. Various techniques for implementing the method 300 are illustrated in FIG. 4. The reader is suggested to refer to FIGS. 2, 3 and 4 simultaneously.

The method 300 begins at step 302 and proceeds to step 304. At step 304, the depository 210_{A} for sender mail 405 is provided. The mail 405 generally includes sender instructions 406 and a sender behest 408 and is addressed to the depository 210_{A}.

The depositories 210 (discussed above in reference to FIG. 2) and 210_{A} include same functional units, however, in the depository 210_{A} these units are adapted for processing the instructions 406, behest 408 and, optionally, parcels 204₁-204_{N}.

At step 306, the parcels 204₁-204_{N} and mail 405 are assembled (e.g., by the sender at the location 200). The instructions 406 and behest 408 generally are notarized, certified, witnessed or signed by the sender paper documents.

The parcels 204₁-204_{N} are selectively addressed to their respective recipients 230₁-230_{N}, sealed and deposited in a sender post-office (P.O.) box 402 of the network 240 (e.g., at the facility 242) or in a sender safe deposit box 404 of a financial services entity 424 (e.g., bank, credit union, etc.), as illustrated with arrows 401, 403. In one embodiment, the sender registers, assigns or appoints the depository 210_{A} as a joint/authorized user of the boxes 402 or 404.

The instructions 406 are addressed to the depository 210_{A}. In one embodiment, the instructions 406 include the listing of the pre-determined events discussed above in reference to step 104 of the method 100, a listing of the parcels 204₁-204_{N} and addressees 230₁-230_{N}, and contact information of an operator of the P.O. box 402 or safe deposit box 404 (e.g., common carrier/network 240/facility 242 or entity 424).

In one embodiment, the behest 408 is addressed to the operator of the P.O. box 402 (or safe deposit box 404) and includes a directive to dispatch the deposited therein parcels 204₁-204_{N} to their recipients 230₁-230_{N}. Alternatively, the behest 408 includes a directive to the respective operator to forward the deposited therein parcels 204₁-204_{N} to the depository 210_{A}.

At step 308, the mail 405 is sent to and received by the depository 210_{A}, where the instructions 406, behest 408 and notices from the Informed Persons 232 and/or Records 234 are processed as discussed above in reference to the instructions 206 and such notices in step 108 of the method 100. Prior to receipt of the notices, the sender may request the depository 210_{A} to replace or return the instructions 406 or behest 408.

At step 310, after detecting/verifying a notice of occurrence of one of the pre-determined by the sender events, the depository 210_{A} forwards the behest 408 to the operator of the P.O. box 402 (or safe deposit box 404). In one embodiment, executing the behest, the operator dispatches the parcels 204₁-204_{N} to the recipients 230₁-230_{N}. In other embodiment, the operator forwards the parcels 204₁-204_{N} to the depository 210_{A}, which dispatches these parcels to the recipients 230₁-230_{N}. The behest 408 may be provided via the network 240 (as depicted), electronically or both. Upon completion of step 310, the method 300 ends at step 312.

Aspects of the present invention have been described with respect to steps of the methods 100 and 300. However, the invention may alternatively be implemented as a system having facilities (e.g., depository 210 or 210_{A}, network 240, P.O. boxes 402 and safe deposit boxes 404, etc.) adapted for implementing steps of these methods and therefore representing an alternative embodiment of the invention.

Correspondingly, portions of steps of the methods 100 and 300 may be presented in a form of processor-readable instructions embedded in computer-readable medium and defining features of the invention. A program product having such instructions, as well as signal-bearing media carrying the instructions also represent an alternative embodiment of the invention.

Although the present invention has been described herein with reference to particular preferred embodiments thereof, these embodiments are merely illustrative of the principles and applications of the invention. Therefore, modifications may be made to these embodiments and other arrangements may be devised without departing from the spirit and scope of the invention, which is defined by the appended claims.

1. A method of dispatching non-electronic Will/Testament documents pre-scheduled for delivery after death or disappearance of a sender, comprising:
(a) forming a plurality of first assemblies selectively addressed to recipients of the sender, each of the first assemblies including a parcel containing a pre-defined by the sender portion of the documents and the recipients including (i) beneficiaries and estate executors of the sender and (ii) a probate court having jurisdiction over a municipality of residence or estate of the sender;
(b) producing a first document including sender instructions for dispatching the parcels after the death or disappearance of the sender;
(c) forming a second assembly including the first document and the plurality of the first assemblies; and
(d) providing the second assembly by a delivery services network of a common carrier to a depository performing:
storing by automated loading/unloading equipment portions of the second assembly in a shelf compartment or a transportable container;
by mail obtaining a judicial decision regarding an event of the death or disappearance of the sender; and
dispatching the plurality of the first assemblies by the network of the common carrier to the recipients.

2-3. (canceled)

4. The method of claim 1, wherein step (d) is further comprising:
dispatching the plurality of the first assemblies after receiving a Death Certificate of the sender.

5. The method of claim 1, wherein the depository is a portion of (i) a financial or insurance business entity or (ii) the common carrier.

6-15. (canceled)

16. A method of dispatching non-electronic Will/Testament documents pre-scheduled for delivery after death or disappearance of a sender, comprising:
(a) producing:
a first document including sender notes disclosing a location of the documents in a safe deposit box or safe; and
a second document including a sender authorization for accessing the documents;
(b) forming a plurality of first assemblies selectively addressed to recipients of the sender, each of the first assemblies including a parcel containing the first document and the second document and the recipients including (i) beneficiaries and estate executors of the sender and (ii) a probate court having jurisdiction over a municipality of residence or estate of the sender;
(c) producing a third document including sender instructions for dispatching the parcels after the death or disappearance of the sender;
(d) forming a second assembly including the third document and the plurality of the first assemblies; and
(e) providing the second assembly by a delivery services network of a common carrier to a depository performing:
storing by automated loading/unloading equipment portions of the second assembly in a shelf compartment or a transportable container;
by mail obtaining a judicial decision regarding an event of the death or disappearance of the sender; and
dispatching the plurality of the first assemblies by the network of the common carrier to the recipients.

17. The method of claim 16, wherein step (d) is further comprising:
dispatching the plurality of the first assemblies after receiving a Death Certificate of the sender.

18. The method of claim 16, wherein the depository is a portion of (i) a financial or insurance business entity or (ii) the common carrier.
